(19) United States
(12) Patent Application Publication
(10) Pub. No.: US 2005/0203948 A1
(43) Pub. Date: Sep. 15, 2005

(54) Method for influencing market decisions of people

(76) Inventor: Josep Lluis de la Rosa, Girona (ES)

Correspondence Address: RATNERPRESTIA, P O BOX 980, VALLEY FORGE, PA, 19482-0980, US

(21) Appl. No.: 10/800,812

(22) Filed: Mar. 15, 2004

(51) Int. Cl. G06F 17/30

(52) U.S. Cl. 707/103 R

(57) ABSTRACT

A method for influencing people's decisions in the market, the method comprising the steps of:
creating an universe of N attributes Vᵢ=[v₁, v₂, . . . , V_{N}], characteristics or values to be exposed to a person j;
showing the attributes vᵢ to the person j and calculating the importance, weight or sensibility that each of the attributes vᵢ has on the person j for affecting in future decisions in the market to be taken by that person j, and expressing the corresponding results of the calculation as Wᵢⱼ=[w₁ⱼ, w₂ⱼ, . . . , w_{Nj}];
creating databases A=[aᵢⱼ] and P=[pᵢⱼ] including, for every person, the universe of attributes Vᵢ ordered by their weight Wᵢⱼ or by their objective interest Zᵢ=[z₁, z₂, . . . , z_{N}], and consulting the databases A and P and selecting only particular attributes to be shown in the future to that person.

### FIELD OF INVENTION

This invention relates to a method based in the use of a computer for handling databases systems, in particular it refers to a method for affecting on peoples decisions in the market by handling some databases reflecting people's likings. The method comes in useful particularly in the field of advertisements or publicity.

### BACKGROUND OF THE INVENTION

There are many documents related to performing operations in a commercial database for different purposes. An example of those documents is U.S. Appl. No. 2002/0133476. It relates to a method for performing operation in a database system in which a plurality of data sets are stored into a storage of a computer, characterized by each data set consisting of an arbitrary number of fields, each consisting of a field description as metadata and an arbitrary number of field contents, whereas in the field description there is provided an attribute for each field content which describes the field content, and during each storage of a data set in a storage of a computer the field contents together with the corresponding metadata being stored as a data set. No reference to applying the method to the field of advertisements or publicity is done in that document.

It's also well known that advertising has generally been displayed or broadcast to masses of potential customers, such as by print media, radio and television, billboards, etc. In some special cases, advertising is narrowcast, i.e. transmitted or supplied to special classes of potential customers, such as by push technology used in the Internet World Wide Web data distribution. There are also documents in the prior art that aims to directed advertising to sets of beforehand identified persons or classes of persons.

One of those documents is U.S. Appl. No. 2003/0103644 which reveals a method for presenting advertising to a person, comprising storing plural advertisements in a memory, detecting the presence of a person adjacent a display apparatus, selecting one of the plural advertisements, and displaying the selected advertisement via the display apparatus upon detection of the person adjacent the display apparatus. This document proposes displaying those advertisements to a specific person or class of persons through the display apparatus, based on a database stored in a memory which contains correlations of advertisements with at least the one person or class of persons.

Another document related to personalizing advertisements is U.S. Appl. No. 2003/0229531, which proposes modifying advertisement scores based on advertisement response probabilities. The method is carried out in a network environment that includes at least an advertisement computer system, and is purely based on statistics instead that focused on a specific person.

### SUMMARY OF THE INVENTION

It appears of interest to provide a method allowing to direct precise or tailored information to a specific person, particularly advertisements, and so being able to influence, through the information presented, future market decisions of the person related to a particular market product or service to be offered, and not limiting its scope to the use of a particular apparatus, a network or to statistics, as the above documents referred to.

The method of the present invention is intended for influencing people's decisions in the market, and comprises the steps of:
creating an universe of N attributes Vᵢ=[v₁, v₂, . . . , v_{N}], characteristics or values to be shown or exposed to a person j,
showing the attributes vᵢ to the person j and calculating the importance, weight or sensibility that each of the attributes vᵢ has on the person j for affecting in decisions in the market to be taken in the future by that person j, and expressing the corresponding results of the calculation as Wᵢⱼ=[w₁ⱼ, w₂ⱼ, . . . . w_{Nj}], and
creating a database A=[aᵢⱼ] including, for every person, the universe of attributes V, ordered by their weight Wᵢ
creating a database P=[pᵢⱼ] including, for every person, the universe of attributes Vi ordered by a corresponding objective interest level Zᵢ=[z₁, z₂, . . . , z_{N}].

The method is further carried out by consulting the database A or databases A and P and selecting from it those attributes vᵢ whose importance, weight or sensibility wᵢⱼ, for the person j, are higher than a specific value, and the showing only them to that person j, or, if also consulting in addition database P, selecting from those attributes vᵢ whose importance, weight or sensibility wᵢⱼ, for the person j, are higher than a specific value, and whose objective interest zᵢ are higher than another specific value, and showing then only them to that person j.

In other words the invention allows predicting what attracts a person (for example a potential client) about an article, a product, an idea, etc., and knowing beforehand which properties that article, product or idea have of interest to be highlighted, or which features a vendor wants to highlight (by any objective reason) from it, matching those features with those characteristics that person feels attracted by, and showing to that person only those matched features an advertisement directed right to that specific person is done.

### DETAILED DESCRIPTION OF THE INVENTION

In order to describe more particularly the present invention with additional specificity and detail, different embodiments will be next portrayed. It must be understood that these descriptions only refer to typical embodiments of the invention and are not therefore to be considered to be limiting of its scope.

The present invention refers to a computer method for influencing people's decisions in the market, the method comprising the steps of:
creating an universe of N attributes Vᵢ=[v₁, v₂, . . . , v_{N}], characteristics or values to be shown or exposed to a person j,
showing the attributes vᵢ to the person j and calculating the importance, weight or sensibility that each of the attributes vᵢ has on the person j for affecting in future decisions in the market to be taken by that person j, and expressing the corresponding results of the calculation as Wᵢⱼ=[w₁ⱼ, w₂ⱼ, . . . , w_{Nj}], and
creating a database A=[aᵢⱼ] including, for every person, the universe of attributes Vᵢ ordered by their weight Wᵢⱼ,
creating a database P=[pᵢⱼ] including, for every person, the universe of attributes Vi ordered by a corresponding objective interest level Zᵢ=[z₁, z₂, . . . , z_{N}].

Attributes are associated with products and/or service to be offered into a market. Attributes may include, by way of non-limiting example, proximity, efficacy, image, price, trademark, etc. In an exemplary embodiment, attributes are weighted based on the importance a subject, e.g., a person or a group, places on the attribute, e.g., 20%, 80%, with regards to a maximum of 100%.

The objective interest level is determined by a vendor who intends to offer products or services into the market. In accordance with this embodiment, the vendor may assign an objective value to each attribute for use in ordering the universe of attributes Vi.

In a first embodiment of the invention it further comprises:
consulting the database A and selecting from it those attributes v, whose importance, weight or sensibility wᵢⱼ, for the person j, are higher than a specific value, and showing then only them to that person j,
   And in a second embodiment the method comprises:
consulting both the databases A and P and selecting from them those attributes vᵢ whose importance, weight or sensibility wᵢⱼ, for the person j, are higher than a specific value, and whose objective interest zᵢ are higher than another specific value, and then showing only them to that person j.

The step of consulting database A (first embodiment) or databases A and B (second embodiment), selecting and showing those attributes vᵢ, are done, in another embodiment, for a group of people instead that for only one person j.

According to one embodiment of the invention, those databases A and P include those attributes vᵢ and their corresponding weight wᵢᵢ, related to every person, by using tuples, wherein [aᵢⱼ]=<vᵢ, wᵢⱼ> of tuples <attribute, weight> and [pᵢⱼ]=<vᵢ, zᵢ> of tuples <attribute, interest>.

Consulting of those databases containing the tuples is done automatically and carried out in general by using a computer and associated program thereof to handle the described method.

In an exemplary embodiment, at least one of those attributes v includes at least two others of those attributes vᵢ.

The attributes vᵢ can be different kind of articles, being then the weight wᵢⱼ of the attributes v, a number which reflects the quantity of a specific article for example likely to be acquired, or can be different characteristics of an article, being then the weight wᵢⱼ of the attributes vᵢ a number which reflects the quantity of articles with a specific characteristic, for example likely to be acquired, depending on the embodiment.

The present invention may be embodied in other specific forms without departing from its spirit or scope. The described embodiments are to be considered in all respects only as illustrative and not restrictive. The scope of the invention should therefore, be construed by the appended claims rather than by the foregoing description. All changes, which come within the meaning and range of equivalency of the claims, are to be embraced within their scope.

1. A method for influencing market decisions of people in the market, the method comprising the steps of:
creating an universe of N attributes Vᵢ=[v₁, v₂, . . . , v_{N}], characteristics or values to be shown or exposed to a person j, and
showing said attributes vᵢ to said person j and calculating at least one of importance, weight and/or sensibility each of said attributes vᵢ has on said person j for predicting future market decisions of said person j, and expressing the corresponding results of said calculation as Wᵢⱼ=[w₁ⱼ, w₂ⱼ, . . . , w_{Nj}],
wherein the method further comprises at least the steps of
creating a database A=[aᵢⱼ] including, for every person, said universe of attributes Vᵢ ordered by their calculated weight Wᵢⱼ, and
creating a database P=[pᵢⱼ] including, for every person, said universe of attributes Vi ordered by a corresponding objective interest level Zᵢ=[z₁, z₂, . . . , z_{N}].

2. The method of claim 1, further comprising the step of:
consulting said database A and selecting from it those attributes vᵢ whose importance, weight and/or sensibility wᵢⱼ, for said person j, are higher than a specific value, and showing only those selected attributes to said person j.

3. The method of claim 1, further comprising the step of:
consulting both said databases A and P and selecting from them those attributes vᵢ whose importance, weight and/or sensibility wᵢⱼ, for said person j, are higher than a specific value, and whose objective interest level zᵢ are higher than another specific value, and showing only those selected attributes whose objective interest level zᵢ are higher than said another specific value to said person j.

4. The method of claim 2, wherein said steps of consulting said database A, selecting said attributes and showing said selected attributes vᵢ, are done for a group of people instead of only one person j.

5. The method of claim 3, wherein said steps of consulting said databases A and P, selecting said attributes and showing said selected attributes vᵢ, are done for a group of people instead of only one person j.

6. The method of claim 1, wherein said databases A and P include said attributes vᵢ and their corresponding weight wᵢᵢ, related to every person, by using tuples, wherein [aᵢⱼ]=<vᵢ, wᵢⱼ> of tuples <attribute, weight> and [pᵢⱼ]=<vᵢ, zᵢ> of tuples <attribute, interest>.

7. The method of claim 2, wherein said consulting of said database A is done automatically.

8. The method of claim 3, wherein said consulting of said databases A and P is done automatically.

9. The method of claim 2, wherein at least one of said attributes vᵢ includes at least two others of said attributes vᵢ

10. The method of claim 3, wherein at least one of said attributes vᵢ includes at least two others of said attributes vᵢ.

11. The method of claim 1, wherein said attributes vᵢ refer to different articles.

12. The method of claim 1, wherein said attributes vᵢ are different characteristics of an article.

13. The method of claim 10, wherein said weight wᵢⱼ of said attributes vᵢ is a number which reflects at least one of (i) the quantity of a specific article and (ii) articles with a specific characteristic, likely to be acquired.

14. The method of claim 11, wherein said weight wᵢⱼ of said attributes vᵢ is a number which reflects at least one of (i) the quantity of a specific article and (ii) articles with a specific characteristic, likely to be acquired.
